(19) United States
(12) Patent Application Publication
(10) Pub. No.: US 2004/0224223 A1
(43) Pub. Date: Nov. 11, 2004

(54) Battery in watchband

(76) Inventors: Huei-Hsin Sun, Taipei City (TW); Yu-Yu Chuang, Banchiau City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/430,937

(22) Filed: May 7, 2003

(51) Int. Cl. H01M 2/02; H01M 6/46

(52) U.S. Cl. 429/127; 429/149; 429/176

(57) ABSTRACT

A battery comprises a plurality of connected, thin cells mounted in a band of a watch. Each cell is (or a unit of cells are) disposed in one of a plurality of links of a watchband of the watch or either one of two snapping members at ends of the watchband. The invention is also applicable in wrist antennas, mobile phones, or digital cameras.

### BACKGROUND OF THE INVENTION

1. Field of the Invention

The present invention relates to small, thin cells and more particularly to an improved battery mounted in a watchband or the like.

2. Description of Related Art

Conventionally, a cell is classified as lithium cell, nickel-hydrogen cell, or cadmium-nickel cell. It is also understood that the higher voltage generated by the cell the higher unit weight of the cell will be. In other words, typically, for generating a high voltage a larger cell is required. This may adversely affect the development of, for example, modern portable communication devices which usually are powered by small cell(s). Thus, the need for improvement still exists.

### SUMMARY OF THE INVENTION

It is an object of the present invention to provide a battery, comprising a plurality of connected, thin cells mounted in a band of a female watch wherein each cell is disposed in one of a plurality of links of a watchband of the watch or either one of two snapping members at ends of the watchband.

It is another object of the present invention to provide a battery, comprising a plurality of connected groups of a plurality of thin cells mounted in a band of a male watch wherein each group of the cells are disposed in one of a plurality of links of a watchband of the watch or either one of two snapping members at ends of the watchband.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of battery mounted in a band of female watch according to the invention; and

FIG. 2 is a perspective view of a second preferred embodiment of battery mounted in a band of male watch according to the invention.

### DETAILED DESCRIPTION OF THE PREFERRED EMBODIMENTS

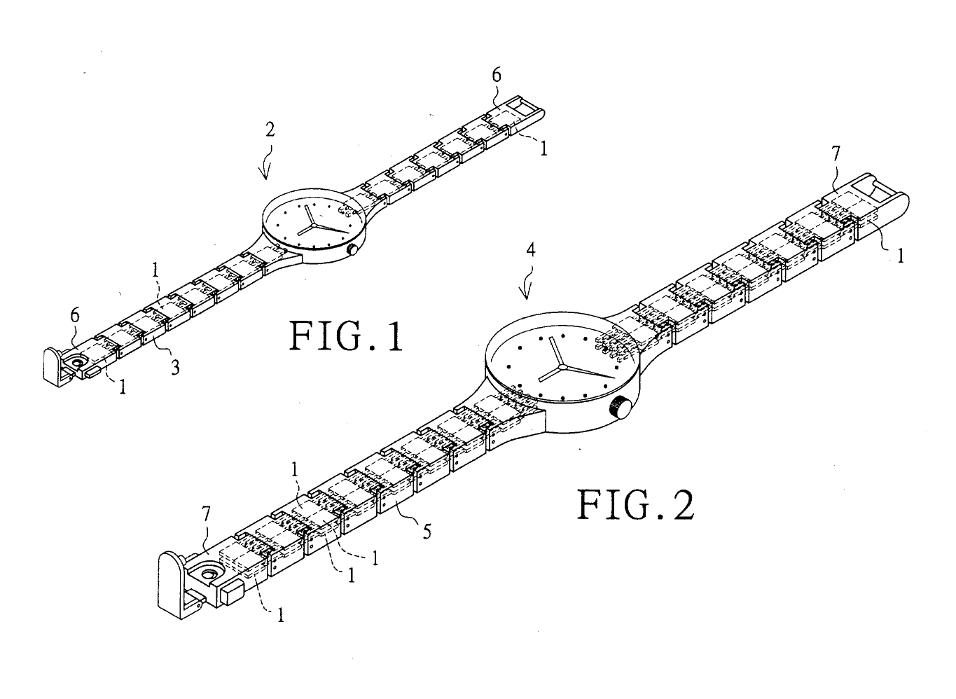

Referring to FIG. 1, there is shown a first preferred embodiment of the invention. A plurality of connected, thin, and small cells 1 of rectangular or square shape are mounted in a band of a small watch (e.g., female watch) 2 in which each cell 1 is mounted in one of a plurality of links 3 of the watchband or either one of two snapping members 6 at the ends of the watchband.

Referring to FIG. 2, there is shown a second preferred embodiment of the invention. A plurality of connected groups of four thin, small cells 1 of rectangular or square shape are mounted in a band of a large watch (e.g., male watch) 4 in which each group of cells 1 are mounted in one of a plurality of links 5 of the watchband or either one of two snapping members 7 at the ends of the watchband.

The linear arrangement of cells 1 may be used in other applications such as wrist antennas, mobile phones, digital cameras, or the like.

While the invention herein disclosed has been described by means of specific embodiments, numerous modifications and variations could be made thereto by those skilled in the art without departing from the scope and spirit of the invention set forth in the claims.

What is claimed is:

1. A battery, comprising a plurality of connected, thin cells mounted in a band of a watch wherein each cell is disposed in one of a plurality of links of a watchband of the watch or either one of two snapping members at ends of the watchband.

2. The battery of claim 1, wherein the watch is a small female watch.

3. A battery, comprising a plurality of connected groups of a plurality of thin cells mounted in a band of a watch wherein each group of the cells are disposed in one of a plurality of links of a watchband of the watch or either one of two snapping members at ends of the watchband.

4. The battery in watchband of claim 3, wherein the watch is a large male watch.
